(19) United States
(12) Patent Application Publication
(10) Pub. No.: US 2004/0221497 A1
(43) Pub. Date: Nov. 11, 2004

(54) Illuminated memory album page

(76) Inventor: Kurt C. Launey, Terrytown, LA (US)

Correspondence Address: THOMAS S. KEATY, KEATY PROFESSIONAL LAW CORP., 2140 WORLD TRADE CENTER, NO. 2 CANAL STREET, NEW ORLEANS, LA, 70130, US

(21) Appl. No.: 10/871,088

(22) Filed: Jun. 18, 2004

Related U.S. Application Data
(63) Continuation-in-part of application No. 10/278,413, filed on Oct. 22, 2002.

(51) Int. Cl. G09F 13/22

(52) U.S. Cl. 40/544; 40/768

(57) ABSTRACT

A page for a memory album or a scrapbook has an illumination assembly secured between adjacent sheets of the page. The illumination assembly has a power source and one or more light emitting members powered by the power source. The light emitting member(s) are mounted opposite one or more openings formed in the page to allow light emitted by the light emitting member to be visible on the front surface of the page. An on/off switch is mounted on the carrier, which is secured to the back of the page to allow a user to selectively activate the light-emitting member by depressing the location on the page which overlays the switch. A rigid eyelet may be mounted in a surrounding relationship over each opening to protect the sheets of the album. A resistance member is incorporated into a programmable electronic circuit to regulate the supply of power to the light emitting members and extend the life of the power source. The illumination assembly allows personalization of the design on the page of the scrapbook.

### CROSS-REFERENCE TO RELATED APPLICATIONS

This application is a continuation-in-part of my co-pending application Ser. No. 10/278,413, filed on Oct. 22, 2002, entitled “Memory Album Page,” the full disclosure of which is incorporated by reference herein.

### BACKGROUND OF THE INVENTION

This invention relates to electrically illuminated pages and more particularly to a memory album page, which is provided with decorative features, such as steady, intermittent or blinking lights that can be visible on the upper surface of the page.

Collection and retention of memorabilia items has long been a favorite hobby of many individuals. Photo albums have been extensively used for retaining photographs on photo album pages by positioning photographs in specially provided pockets, retaining photographs between a firm page and a transparent cover, by engaging corners of the photographs in mounted brackets attached to the photo album page and by other similar means.

In recent years, collectors and hobbyists have been using the so-called “scrapbooks” for retaining objects that have monetary or purely sentimental value. Some of the items retained in the scrapbook pages may be collectibles that have historic value, such as invitations to important political functions, concert tickets, letters from notable individuals and the like. However, majority of the individuals uses scrapbooks for retaining items of purely sentimental value, such as photographs, wedding invitations, holiday greetings and the like.

Scrapbooks or albums are available from a variety of sources in different designs, varying in shapes, sizes, number of pages in the scrapbook, etc. Generally, scrapbooks have front and back covers of sturdy construction joined by a spine with a plurality of pages retained between the covers. The pages themselves are designed for retaining the memorabilia, photographs, drawings, and the like.

The pages of the commercially sold scrapbooks are usually blank, allowing the user to display the items in any desired order on the page and then decorate the page according to the individual's taste and imagination. The individual may incorporate writings, drawings, or small three-dimensional objects to supplement the story told by a photograph and enhance the visual effect of the page. Art supply and stationary stores also sell a variety of preprinted designs that can be glued to the page together with a photograph, invitation, or a postcard to further personalize the scrapbook page.

The present invention contemplates provision of a means for personalizing the pages of a memory album, such as a scrapbook, by incorporating an illumination means secured between the sheets of a scrapbook page, such that illumination is provided on the front viewing surface of the page.

### SUMMARY OF THE INVENTION

It is, therefore, an object of the present invention to provide a kit for personalizing memory album pages with an illumination means.

It is another object of the present invention to provide a memory album page that can be personalized by incorporating an illumination means into the viewing area of the page that can work in sequence to produce a “blinking” effect.

It is a further object of the present invention to provide a page for a scrapbook, which can be illuminated by light emitting diodes having any desired color covering and operating in a steady fashion or in sequence.

These and other objects of the present invention are achieved through a provision of a page for a memory album that has a first sheet, a second sheet and an illumination assembly “sandwiched” between the sheets. The illumination assembly has one or more light emitting members programmed to light in a steady fashion or intermittently. A resistance member forms a part of the illumination assembly to facilitate regulation of power supply to the light emitting member(s). The illumination assembly uses surface mounted technology.

An eyelet is mounted in a surrounding relationship about an opening through which the light-emitting member extends on the top sheet. The eyelet is formed from a rigid material and protects soft flexible sheet that forms the page of the scrapbook.

### BRIEF DESCRIPTION OF THE DRAWINGS

Reference will now be made to the drawings, wherein like parts are designated by like numerals and wherein:

FIG. 1 is a perspective view of a memory album with various decorations of individual pages.

FIG. 2 is an exploded view of part of a scrapbook page with the illumination assembly mounted between adjacent sheets of the page.

FIG. 3 is a detail view illustrating several design drawings showing the sequence of illumination for creating of “blinking” effect on the page.

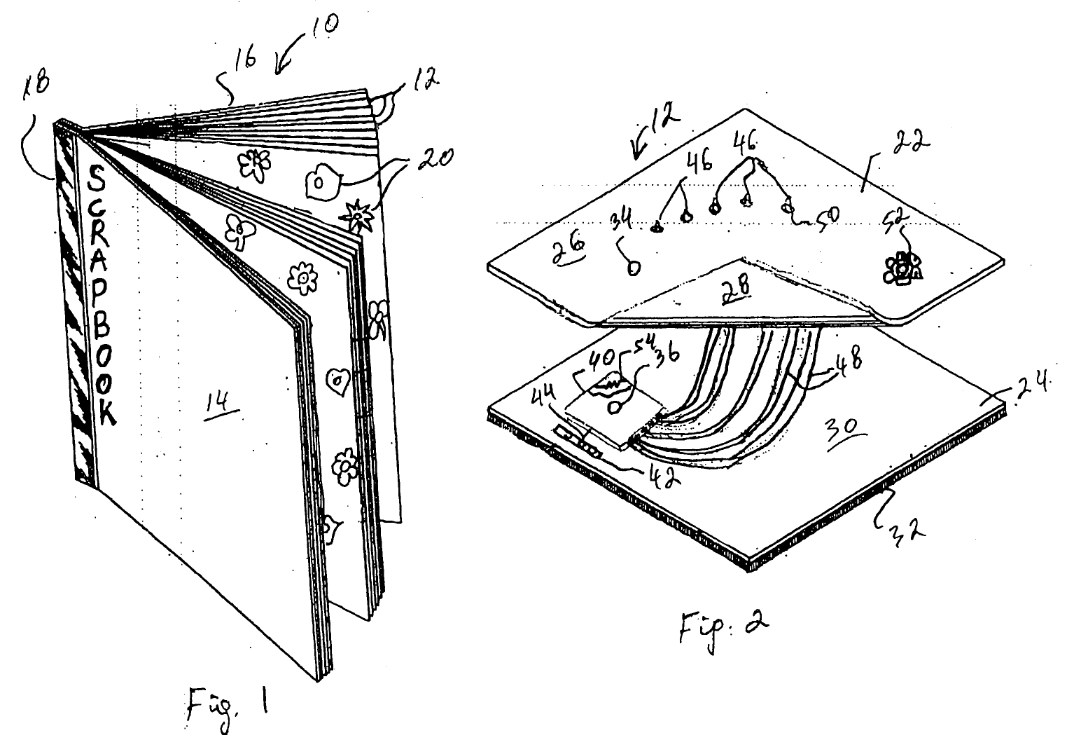

### DETAILED DESCRIPTION OF THE PREFERRED EMBODIMENT

Turning now to the drawings in more detail, numeral 10 designates a scrapbook, which incorporates pages with illumination means in accordance with the present invention. The memory album comprises a plurality of pages 12 secured between a front cover 14 and a back cover 16. The covers 14, 16, as well as the pages 12 are bound together by a spine 18 to form a unitary item, in this case a memory album. Blank pages of the memory album 10 can be decorated with various designs 20 imprinted, glued or otherwise displayed on the front, viewing surface of the page 12.

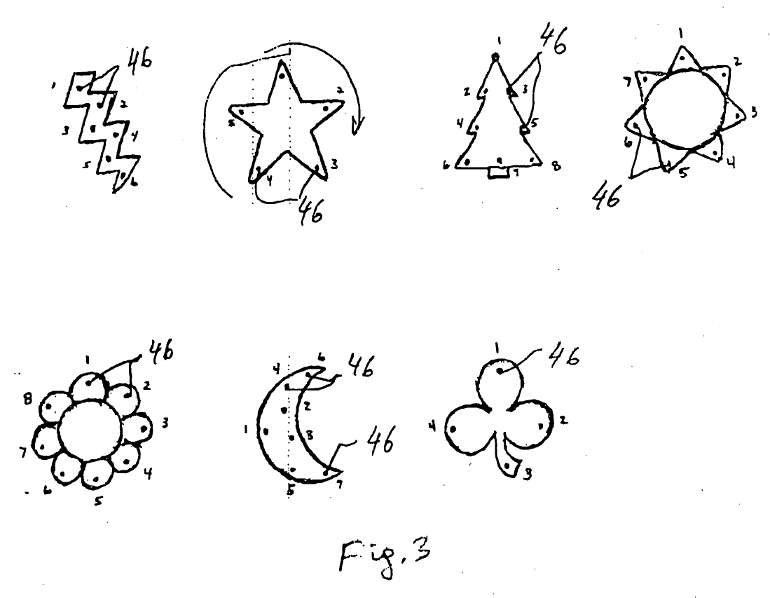

Turning now to FIG. 2, a portion of one of the pages 12 is illustrated in more detail. Each page 12 has a first, top sheet 22 and a second, bottom sheet 24. The first sheet 22 has a top front surface 26 and a back surface 28. The second sheet 24 has a front surface 30 and a back surface 32. An opening 34 is formed through the thickness of the first sheet 22 for receiving an on/off switch 36 which forms a part of the illumination assembly, or module 40 of the assembly of the present invention.

The illumination assembly 40 is shaped as a flat, thin body in a size preferably smaller than the peripheral dimensions of the sheets 22 and 24. A power source, such as a battery pack 42 is operationally connected to the module 40 by conventional wiring 44, providing power to the module 40 and the illumination member(s) 46. Lengths of wire 48 connect the module 40 to the light emitting members 46

The battery pack 42 may have two or three batteries positioned therein to provide sufficient illumination to a plurality of light emitting members 46. The batteries in the battery pack 42 can be each 2-3 volts, with the entire power pack producing a 6-volt system to facilitate a long-life illumination for each memory album page 12.

The light emitting members 46 may have different color coverings to create a desired visual effect. If desired, the light emitting members 46 may comprise a colored to provide even greater intensity of the light on the page 12. The light-emitting members 46 may be mounted within suitable plugs allowing exchanging of the light-emitting member 46 for other colors when desired.

Each light emitting member 46 extends through a corresponding opening 50 formed in the sheet 22. It was observed that the soft flexible sheets of the memory album become damaged when the light emitting members are forced through the openings in the top sheet. To protect the pages, the present invention contemplates provision of a rigid eyelet 52, which is placed in a surrounding relationship about each opening 50. The eyelet 52 may be inserted as a small grommet by first puncturing a hole in the sheet 22 and then placing a grommet therein. The central opening in the grommet or eyelet 52 is sufficient to allow the light emitting member 46 and/or associated plug to extend therethrough. The eyelets 52 may be formed of plastic, lightweight non-corrosive metal and other such suitable rigid material.

The light emitting members 46 can be positioned in any desired location or combination on the page 12. As can be seen in FIG. 3, the light-emitting members 46 may be surrounded by a desired indicia, for instance a drawing of a star, a flower, tree, etc. The module 40 can be programmed to allow either a steady supply of power to the light emitting member(s) 46, or intermittent supply of power or sequential supply of power to different light emitting members 46 forming a particular pattern, blinking lights, etc.

For instance, if a user wants to create a “lightning bolt” effect on page 12, the user may position the lights in an offset inclined pattern on the page and cause the lights to illuminate starting from the top light emitting member 46 and descending to the bottom light. emitting member 46. If a user desires to create a “Christmas tree” effect on a page 12, the user may position the lights in a generally pyramidal fashion on the page 12 and then have the electronic circuit within the module 40 supply power in sequence to the light emitting members 46 starting from the top of the “tree” and descending to the bottom of the “tree.”

To create a circular design, the user may arrange the openings 50 with the eyelets 52 to form a generally circular design and then have the electronic circuit within the module 40 illuminate the light emitting member 46 in a clockwise or counter clockwise direction. In a similar manner, the light emitting means may be arranged to protrude through the sheet 22 in any fanciful pattern selected by the user. Depending upon the selected pattern, the user may use one or more light emitting members for creating the desired effect on the page 12. In the exemplary patterns shown in FIG. 3, the sequence of illumination of the light emitting means is designated by numerals 1-8, depending on the number of light emitting members 46 used for creating a particular illumination effect.

The battery pack 42, as well as the module 40 can be secured between the sheets 22 and 24 by conventional adhesive. The kit or assembly of the module 40, associated wiring, power source and the light emitting member 46 may employ surface mount technology. The module 40, battery pack 42 and the connecting wiring is secured to lie flat between the surfaces of 28 and 30 of the sheets 22 and 24, respectively.

The batteries included in the battery pack 42 are small flat batteries, for instance small watch batteries that present minimal thickness when secured in the pack 42. The wiring 48 can be arranged to lie flat against the surface 30 and against the surface 28 so as not to substantially increase the thickness of the page 12 in the memory album 10. If desired, the wiring 48 can be firmly secured in a desired location on the surface 30 for creating a more stable position for the light emitting members 46 protruding through the sheet 22.

The on/off switch 36 is a flat button-touch switch that can be manually depressed through the opening 34 to start power flowing to the light emitting members 46. The light emitting members 46 can be chip diodes or light emitting diodes (LEDs) which are readily available from a variety of sources. The light emitting members 46 can be color coordinated with the design on the page.

It was observed that LEDs 46 having particular color coverings have greater brightness than others do. For instance, it was noted that red covered LEDs are brighter than yellow-covered LEDs. As a result, the desired illumination effect may suffer and not achieve the intended purpose of forming a selected pattern. To solve this problem, the electronic circuit within the module 40 comprises at least one resistance member 54, which reduces the draw on the batteries, increasing the life of the battery pack 42, while allowing to divert sufficient power to the light emitting members 46. Therefore, throughout the circuit controlled by the module 40, the brightness of individual light emitting members 46 will be approximately the same.

Once the illumination assembly is positioned between the sheets 22 and 24 and secured at least to one of the sheets, for instance sheet 24, the sheet 22 and 24 can be secured together to conceal the module 40, the associated wiring and the battery pack 42 between the sheets. Only the light emitting members 46 and the switch 36 are allowed to protrude through the sheet 22.

The illuminated memory album page of the present invention can be used for enhancing the design of the scrapbook page 12 and for illuminating an object of a particular interest on the page. If desired, an illumination assembly consisting of the module 40, battery pack 42, wiring 48, eyelets 52 and the light emitting members 46 can be sold separately as a kit, allowing the user to selectively choose the number of light emitting members 46 that are needed for enhancement of a particular page.

The user can selectively provide openings in a desired location on the page, forming an outline of an object, forming a fanciful figure and the like that will be illuminated once the switch 36 is depressed. The on/off switch 36 allows to control the supply of power to the light emitting members 46 and to save the battery life. Page 12 in the scrapbook 10 can be provided with the optional instructional page, showing designs similar to the schematic designs of FIG. 3 to help users select the desired module 40. It is envisioned that some of the pages 12 may be used for photographs or a full-page greeting card, without the illumination assembly.

If desired, the on/off switch 36 may be eliminated from the illumination assembly. Instead, opening of the page 12 in a particular location within the album 10 will complete the electrical circuit between the light emitting members 46 and the power pack 42. Once the page is opened, the light-emitting members 46 become activated illuminating the selected design on the visible surface 26 of the page 12.

Many other changes and modifications can be made in the design of the present invention without departing from the spirit thereof. I, therefore, pray that my rights to the present invention be limited only by the scope of the appended claims.

I claim:

1. A memory album page, comprising:
a flat sheet having a front surface and a back surface, said sheet provided with at least one opening therethrough; and
an illumination assembly mounted to the back surface of said sheet, said illumination assembly comprising at least one light emitting member emitting light through said opening and a programmable electronic circuit for regulating operation of said at least light emitting member.

2. The memory album page of claim 1, wherein said electronic circuit comprises at least one resistance member.

3. The memory album page of claim 1, wherein said illumination assembly further comprises a source of electrical power for energizing said at least one light emitting member.

4. The memory album page of claim 1, further comprising at least one rigid eyelet mounted in a surrounding relationship about said at least one opening.

5. The memory album page of claim 1, wherein said illumination assembly further comprises an on/off switch for controlling operation of said at least one light emitting member.

6. The memory album page of claim 2, wherein said illumination assembly further comprises a power source and a means for connecting said at least one light emitting member and said at least one resistance member to said power source.

7. The memory album page of claim 1, wherein said at least one light emitting member is a light emitting diode.

8. The memory page album of claim 1, wherein said electronic circuit comprises a means for intermittent interruption of light transmitted by said at least one light emitting member.

9. The assembly of claim 1, further comprising a plurality of light emitting members, each of said light emitting members having a pre-determined color covering for enhancing visual effect created by said light emitting members.

10. The memory album page of claim 9, wherein said electronic circuit comprises a programmable means for causing sequential supply of power to said light emitting members.

11. A kit for illuminating a page in a memory album, the kit comprising:
a carrier;
a power source secured on said carrier; an electronic circuit secured on said carrier operationally connected to said power source; and
at least one light emitting member operationally connected to said electronic circuit.

12. The kit of claim 11, wherein said electronic circuit comprises a means for intermittent supply of power to said at least one light emitting member.

13. The kit of claim 11, further comprising an on/off switch secured on said carrier for controlling operation of said at least one light emitting member.

14. The kit of claim 11, wherein said electronic circuit comprises at least one resistance member.

15. The kit of claim 11, further comprising a power source for supplying electrical power to said electronic circuit and said at least one light emitting member.

16. A scrapbook page, comprising:
a first flat sheet having a front surface and a back surface, said first sheet being provided with an opening therethrough;
a second flat sheet having a front surface and a back surface;
an illumination assembly positioned between back surfaces of said first sheet and said second sheet, said illumination assembly comprising at least one light emitting member positioned opposite said opening and a programmable electronic circuit operationally connected to said at least one light emitting member.

17. The scrapbook page of claim 16, further comprising at least one rigid eyelet positioned in a surrounding relationship about said at least one opening, and wherein said at least emitting member extends through said eyelet.

18. The scrapbook page of claim 16, wherein said illumination assembly further comprises a carrier and a power source mounted on said carrier, said power source supplying electrical power to said least one light emitting member.

19. The scrapbook page of claim 16, wherein said at least one light emitting member is a light emitting diode.

20. The scrapbook page of claim 16, further comprising a means for intermittent interruption of light transmitted by said at least one light emitting member.

21. The scrapbook page of claim 16, wherein said illumination assembly further comprises an on/off switch mounted on said carrier in operational connection with said power source for activating said at least one light emitting member.

22. The scrapbook page of claim 16, wherein said illumination assembly further comprises a plurality of light emitting members, each of said light emitting members having a pre-determined color covering.

23. The scrapbook page of claim 22, wherein said illumination assembly comprises at least one resistance member for regulating supply of power to said light emitting members.

24. The scrapbook of claim 22, wherein said illumination assembly further comprises a means for regulating sequential supply of power to said light emitting members.
